(19) United States
(12) Patent Application Publication
(10) Pub. No.: US 2024/0345614 A1
(43) Pub. Date: Oct. 17, 2024

(54) BANDGAP REFERENCE CIRCUIT AND METHOD OF TESTING AND CALIBRATING THE SAME

(71) Applicant: TRITIUM ELECTRONICS PTE. LTD., Singapore (SG)

(72) Inventor: Zhi-Xin CHEN, Hsinchu County (TW)

(21) Appl. No.: 18/621,008

(22) Filed: Mar. 28, 2024

Related U.S. Application Data
(60) Provisional application No. 63/495,771, filed on Apr. 12, 2023.

(51) Int. Cl. G05F 3/30; G01K 7/01; G05F 1/567

(52) U.S. Cl. CPC G05F 3/30

(57) ABSTRACT

A bandgap reference circuit includes: plural bipolar transistors; plural resistors; plural switches; and a feedback control circuit which includes an amplifier and a subset of the plurality of resistors. The bipolar transistors, the resistors and the feedback control circuit generate a positive temperature coefficient signal and a negative temperature coefficient signal, and generate a bandgap reference voltage according to a linear superposition of the positive temperature coefficient signal and the negative temperature coefficient signal. The bandgap reference circuit has plural variance parameters which influence a temperature coefficient and/or an offset voltage of the bandgap reference voltage. During a calibration process, the plural switches configure the bandgap reference circuit to operate in corresponding calibration configurations, wherein each of a first subset of the variance parameters is measured individually to calibrate the temperature coefficient or the offset voltage of the bandgap reference voltage.

### CROSS REFERENCE

The present invention claims priority to U.S. 63/495,771, filed on Apr. 12, 2023.

### BACKGROUND OF THE INVENTION

### Field of Invention

The present invention relates to a bandgap reference circuit, and in particular to a bandgap reference circuit which can effectively improve the accuracy of single-point temperature calibration of the bandgap reference voltage, and a test and calibration method thereof.

### Description of Related Art

FIG. 1A shows a schematic diagram of a conventional bandgap reference circuit. FIG. 1B shows a temperature characteristic curve of the bandgap voltage corresponding to FIG. 1A. Referring to FIGS. 1A and 1B, in this conventional bandgap reference circuit, to calibrate and compensate for the temperature coefficient of the bandgap reference voltage Vref′, it requires to obtain voltages corresponding to two or more temperatures under control, i.e., to obtain two or more pairs of numbers, such as (Vref1, T1) and (Vref2, T2). Therefore, the calibration is relatively costly and time-consuming.

In view of this, the present invention proposes a bandgap reference circuit which can calibrate and compensate for the temperature coefficient of the bandgap reference voltage under single-point temperature control or even under no control of the ambient temperature.

### SUMMARY OF THE INVENTION

In one aspect, the present invention provides a bandgap reference circuit comprising: a plurality of bipolar transistors, including a first bipolar transistor and a second bipolar transistor, wherein the first bipolar transistor and the second bipolar transistor are biased at different current densities; a plurality of impedance devices of a same type; a plurality of switches; and a feedback control circuit, including an amplifier and a part of the impedance devices, wherein a first input terminal of the amplifier is coupled to the first bipolar transistor, and a second input terminal of the amplifier is coupled to the second bipolar transistor through one of the part of impedance devices; wherein the plurality of bipolar transistors, the plurality of impedance devices, and the feedback control circuit are configured to generate a positive temperature coefficient signal and a negative temperature coefficient signal, and to generate a bandgap reference voltage according to a linear superposition of the positive temperature coefficient signal and the negative temperature coefficient signal; wherein the bandgap reference circuit has a plurality of variance parameters affecting a temperature coefficient and/or an offset voltage of the bandgap reference voltage, wherein in a calibration process, the plurality of switches are controlled to configure the bandgap reference circuit to operate in a plurality of corresponding calibration configurations, and in the calibration configurations, a first subset of the variance parameters are measured separately, to individually calibrate an impact of a variation of each of the first subset of variance parameters on the temperature coefficient or the offset voltage of the bandgap reference voltage, wherein the offset voltage refers to an offset component in the bandgap reference voltage that is independent of temperature.

In one embodiment, the first subset of variance parameters include at least one of the following: a unit impedance value related to the plurality of impedance devices, a current gain of the plurality of bipolar transistors, and a non-ideal factor.

In one embodiment, the plurality of variance parameters includes a second subset of variance parameters, wherein the calibration process further includes measuring the bandgap reference voltage after the first subset of variance parameters have been calibrated, and based on the measured bandgap reference voltage, calculating and calibrating the second subset of variance parameters.

In one embodiment, the second subset of variance parameters include a reverse saturation current of the bipolar transistors.

In one embodiment, the calibration process further includes measuring and calibrating the first subset and the second subset of variance parameters at a single temperature, so that the calibration of the temperature coefficient and offset voltage of the bandgap reference voltage is achieved at the single temperature.

In one embodiment, the calibration process further includes: when measuring each of the variance parameters, also measuring a present ambient temperature of the bandgap reference circuit by a thermometer, and based on a variation of the variance parameter and a corresponding present ambient temperature, measuring and calibrating the first subset and second subset of variance parameters, to achieve calibration of the temperature coefficient and offset voltage of the bandgap reference voltage.

In one embodiment, the calibration process further includes: not controlling the ambient temperature.

In one embodiment, the plurality of variance parameters are calibrated by steps including a direct or indirect measurement.

In one embodiment, the first subset of variance parameters and/or the second subset of variance parameters include at least one temperature coefficient variance parameter that affects the temperature coefficient of the bandgap reference voltage, wherein the calibration process further includes: adjusting a first adjustment parameter related to the temperature coefficient of the bandgap reference voltage according to a variation of the at least one temperature coefficient variance parameter, thereby calibrating an impact of the variation of the at least one temperature coefficient variance parameter on the bandgap reference voltage.

In one embodiment, the first adjustment parameter is related to a ratio between the positive temperature coefficient signal and the negative temperature coefficient signal.

In one embodiment, the at least one temperature coefficient variance parameter includes the unit impedance value, the current gain, and/or the reverse saturation current.

In one embodiment, the plurality of variance parameters includes at least one offset voltage variance parameter that affects the offset voltage of the bandgap reference voltage, wherein the calibration process further includes: adjusting a second adjustment parameter related to the offset voltage of the bandgap reference voltage according to a variation of the at least one offset voltage variance parameter, thereby calibrating an impact of the variation of the at least one offset voltage variance parameter on the bandgap reference voltage.

In one embodiment, the second adjustment parameter is related to a gain of the bandgap reference voltage.

In one embodiment, the at least one offset voltage variance parameter includes the non-ideal factor.

In one embodiment, during the calibration process, the plurality of switches configure at least one of the plurality of impedance devices to operate in an impedance value calibration configuration, which includes: controlling the plurality of switches, so as to measure and obtain an impedance value of the at least one impedance device by voltage division or by a current source generating a current through the at least one impedance device, thereby calculating a variation of the unit impedance value to calibrate an impact of the variation of the unit impedance value on the temperature coefficient of the bandgap reference voltage.

In one embodiment, during the calibration process, the plurality of switches configure the plurality of bipolar transistors to operate in a non-ideal factor calibration configuration, which includes: controlling the plurality of switches, so as to respectively provide currents to the first and second bipolar transistors to generate different current densities in the first and second bipolar transistors, and measuring a difference between base-emitter voltages of the first and second bipolar transistors to calculate a variation of the non-ideal factor, thereby calibrating an impact of the variation of the non-ideal factor on the offset voltage of the bandgap reference voltage.

In one embodiment, during the calibration process, the plurality of switches configure the plurality of bipolar transistors to operate in a current gain calibration configuration, which includes: controlling the plurality of switches, so as to provide current to an emitter of one of the bipolar transistors; and measuring a base current of this one bipolar transistor to calculate a variation of the current gain, to thereby calibrate an impact of the variation of the current gain on the temperature coefficient of the bandgap reference voltage.

In one embodiment, during the calibration process, the plurality of switches configure the bandgap reference circuit to operate in a reverse saturation current calibration configuration, which includes: after the first subset of variance parameters have been calibrated, controlling the plurality of switches, so as to measure an error in the bandgap reference voltage; and based on this error in the bandgap reference voltage, calibrate an impact of the variation in the reverse saturation current on the temperature coefficient of the bandgap reference voltage.

In another aspect, the present invention provides a method for testing and calibrating a bandgap reference circuit, wherein the bandgap reference circuit is configured to generate a positive temperature coefficient signal and a negative temperature coefficient signal, and generate a bandgap reference voltage according to a linear superposition of the positive and negative temperature coefficient signal signals, wherein the bandgap reference circuit has a plurality of variance parameters affecting a temperature coefficient and/or an offset voltage of the bandgap reference voltage, and the bandgap reference circuit including a plurality of switches, the method comprising: controlling the plurality of switches to configure the bandgap reference circuit in corresponding calibration configurations, and in the corresponding calibration configurations, measuring a first subset of variance parameters respectively to calibrate an impact of a variation of each of the first subset of variance parameters on the temperature coefficient or offset voltage of the bandgap reference voltage, wherein the offset voltage refers to a component of the bandgap reference voltage that is independent of temperature.

In one embodiment, the bandgap reference circuit includes a plurality of impedance devices and a plurality of bipolar transistors, and the first subset of variance parameters includes at least one of the following: a unit impedance value related to the plurality of impedance devices, a current gain of the plurality of bipolar transistors, and a non-ideal factor.

In one embodiment, the plurality of variance parameters include a second subset of variance parameters, and the method further comprises: measuring the bandgap reference voltage after the first subset of variance parameters have been calibrated, and based on the measured bandgap reference voltage, calculating and calibrating the second subset of variance parameters.

In one embodiment, the method further comprises: measuring and calibrating the first subset and the second subset of variance parameters at a single temperature, so that the calibration of the temperature coefficient and offset voltage of the bandgap reference voltage is achieved at the single temperature; or, the method further comprises: when measuring each of the variance parameters, also measuring a present ambient temperature of the bandgap reference circuit by a thermometer, and based on a variation of the variance parameter and a corresponding present ambient temperature, measuring and calibrating the first subset and second subset of variance parameters, to achieve calibration of the temperature coefficient and offset voltage of the bandgap reference voltage.

An advantage of the present invention is that can achieve effective improvement of the accuracy of single-point temperature calibration of the bandgap reference voltage by means of measuring and adjusting plural parameters.

The objectives, technical details, features, and effects of the present invention will be better understood with regard to the detailed description of the embodiments below, with reference to the attached drawings.

### BRIEF DESCRIPTION OF THE DRAWINGS

FIG. 1A shows a schematic diagram of a conventional bandgap reference circuit.

FIG. 1B shows a temperature characteristic curve of the bandgap voltage corresponding to FIG. 1A.

FIG. 2 shows a block diagram of a bandgap reference circuit according to an embodiment of the present invention.

FIG. 3 shows a schematic diagram of a bandgap reference circuit according to an embodiment of the present invention.

FIG. 4A shows a schematic diagram of a resistance calibration configuration according to an embodiment of the present invention.

FIG. 4B shows a schematic diagram of a resistance calibration configuration according to another embodiment of the present invention.

FIG. 5 shows a schematic diagram of a non-ideal factor calibration configuration according to an embodiment of the present invention.

FIG. 6 shows a schematic diagram of a current gain calibration configuration according to an embodiment of the present invention.

FIG. 7 shows a schematic diagram of a reverse saturation current calibration configuration according to an embodiment of the present invention.

FIG. 8 shows a schematic diagram of a switchable capacitor circuit according to an embodiment of the present invention.

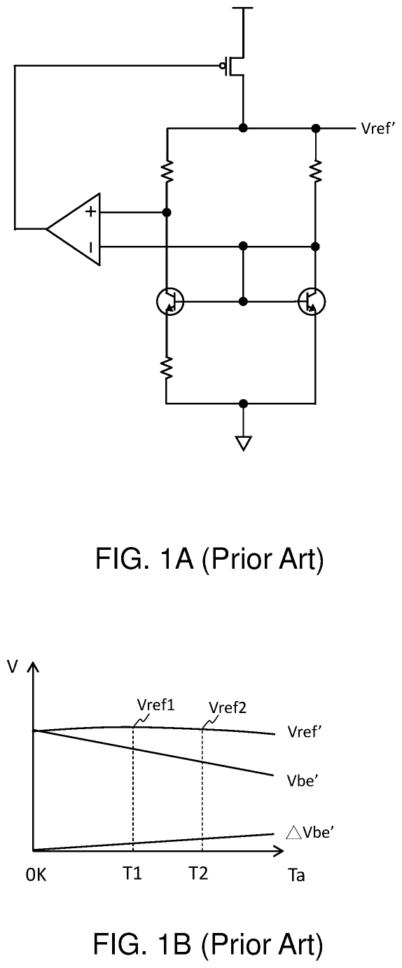

### DESCRIPTION OF THE PREFERRED EMBODIMENTS

The drawings as referred to throughout the description of the present invention are for illustration only, to show the interrelations between the circuits and the signal waveforms, but not drawn according to actual scale.

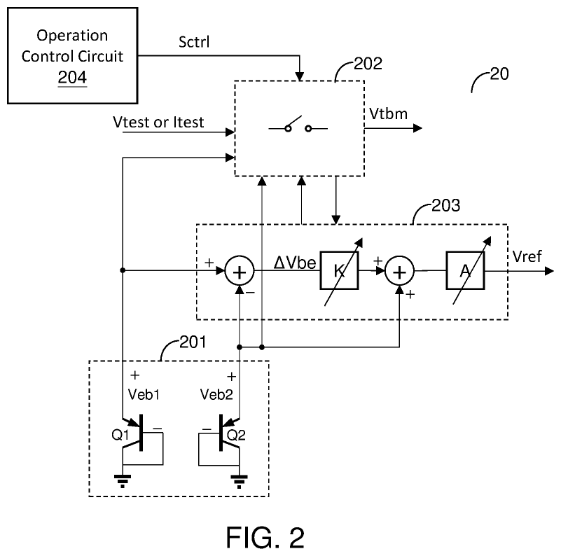

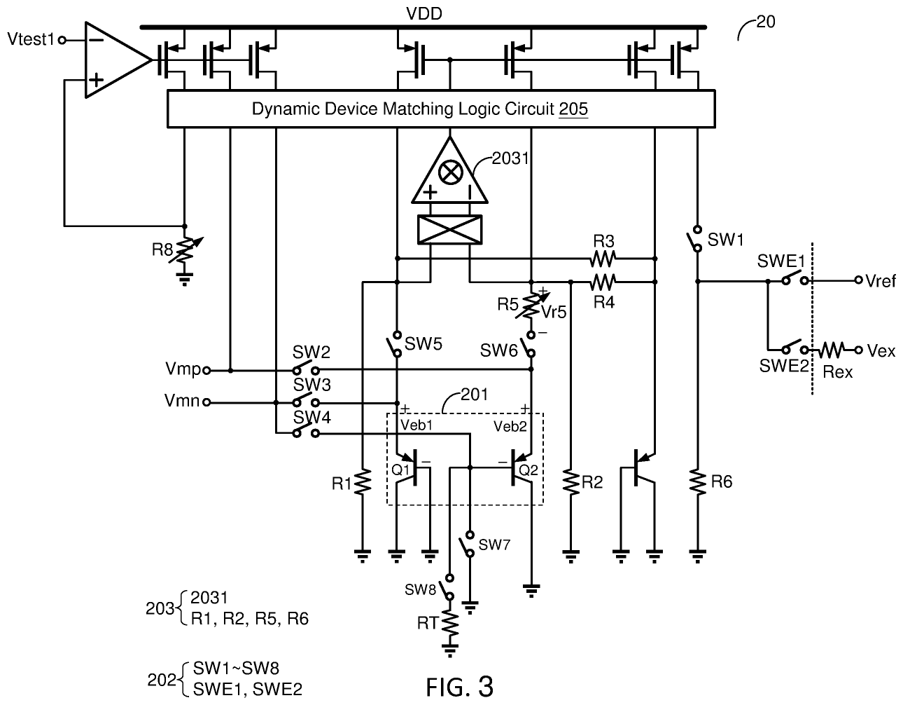

FIG. 2 shows a block diagram of a bandgap reference circuit according to an embodiment of the present invention. As shown in FIG. 2, the bandgap reference circuit 20 of the present invention includes plural bipolar transistors 201, plural resistors (not shown in this figure but shown in FIG. 3), plural switches 202, and a feedback control circuit 203. The plural bipolar transistors 201 include bipolar transistors Q1 and Q2, wherein the bipolar transistors Q1 and Q2 are biased at different current densities. An operation control circuit 204 controls the plural switches 202 by a control signal Sctrl to change the configuration of the feedback control circuit 203, wherein test input signals Vtest or Itest are introduced through the switches 202, and the to-be-measured signal Vtbm is obtained from the feedback control signal 203. The plural bipolar transistors 201, plural resistors, and feedback control circuit 203 generate a positive temperature coefficient signal ΔVbe and a negative temperature coefficient signal (such as the base-emitter voltage Veb2 or Veb1), wherein the positive temperature coefficient signal ΔVbe, for example, is a difference between the base-emitter voltages Veb1 and Veb2. The bandgap reference voltage Vref is generated by linear superposition of the positive temperature coefficient signal ΔVbe and the negative temperature coefficient signal (e.g., the base-emitter voltage Veb2 or Veb1). For example, the bandgap reference voltage Vref can be represented by the following equation:

$$Vref = K 1 * Veb 2 + K 2 * Δ Vbe \qquad ( Eq . 1 )$$

wherein K1 and K2 are real numbers.

The plural resistors are not shown in FIG. 2; they are, for example, included in the feedback control signal 203 within the blocks with the plus sign, with the gain K or gain A. Practical implementation examples will be described later.

FIG. 3 shows a schematic diagram of a bandgap reference circuit according to an embodiment of the present invention. This embodiment is a specific implementation of FIG. 2. The plural bipolar transistors 201 in this embodiment are similar to those in FIG. 2, so the detailed description thereof is omitted. As shown in FIG. 3, the plural resistors include resistors R1 to R6 and RT. In one embodiment, the plural resistors R1 to R6 and RT are of the same type. “The same type” of resistors means that these resistors have at least one identical manufacturing step, and have unit sizes and unit resistances which are correlated with one another, so that they having the same variance or related variances. Rex is an external resistor, which will be detailed later. In this embodiment, the plural switches 202 include switches SW1 to SW8, SWE1, and SWE2. The feedback control circuit 203 includes an amplifier 2031 and a part of the resistors R1 to R6, R8, and RT, for example the resistors R1, R2, R5, and R6. In this embodiment, the first input terminal of the amplifier 2031 (e.g., the positive input terminal) is coupled to the emitter of the bipolar transistor Q1, while the second input terminal of the amplifier 2031 (e.g., the negative input terminal) is coupled through one of the part of resistors, such as resistor R5, to the emitter of the bipolar transistor Q2.

As shown in FIG. 3, the bandgap reference circuit 20 further includes a dynamic element matching logic circuit 205. The dynamic element matching logic circuit 205 is configured to compensate for mismatches between components, such as mismatches between current sources, or input offsets caused by internal mismatches within the amplifier 2031.

With appropriate design of the parameters related to temperature coefficient, such as the aforementioned parameters K1 and/or K2, the temperature coefficient of the bandgap reference voltage Vref can be adjusted to zero. However, the variance in mass production can cause certain parameters to deviate, affecting the temperature coefficient or the offset voltage of the bandgap reference voltage Vref to be different in different dies, causing deviations from the design values. Process-related variance parameters include, for example, the unit resistances of the resistors R1 to R6 and RT, the current gain β of the bipolar transistors, and the reverse saturation current Is and the non-ideal factor ηF of the bipolar transistors 201. In one embodiment, the relationship between the bandgap reference voltage Vref and the variance parameters corresponding to FIG. 3 is as follows:

$$Vref = η F * A * ( Δ Vbe * K + Veb 2 ) \qquad ( Eq . 2 )$$

$$Wherein A = Rv 6 / Rv 2 \qquad ( Eq . 3 )$$

$$K = Rv 2 / Rv 5 \qquad ( Eq . 4 )$$

$$Veb 2 = VT * ln [ ( Δ Vbe / Is ) * ( β / β + 1 ) * ( 1 / Rv 5 ) ] \qquad ( Eq . 5 )$$

$$VT = k * T / q \qquad ( Eq . 6 )$$

wherein the non-ideal factor ηF refers to the non-ideal factor of the bipolar transistor 201; Rv2, Rv5, and Rv6 are the resistances of the resistors R2, R5, and R6, respectively; ΔVbe is the difference between the base-emitter voltages Veb1 and Veb2, which for example can be Vr5 which is the voltage across resistor R5; β is the reverse saturation current of the bipolar transistors 201; β is the current gain of bipolar transistors Q1 and Q2; k is the Boltzmann constant; T is the absolute temperature; and q is the unit charge quantity.

From one perspective, the aforementioned variance parameters include a first subset of variance parameters and a second subset of variance parameters. In one embodiment, the first subset of variance parameters includes the unit resistances of the resistors R1 to R6 and RT, and the current gain β and the non-ideal factor ηF of the bipolar transistors 201. The second subset of variance parameters includes the reverse saturation current Is of the bipolar transistor.

The first subset of variance parameters and the second subset of variance parameters, in one embodiment, are calibrated or corrected using different measurement methods, which will be detailed later.

In one embodiment, during the calibration process, the bandgap reference circuit 20 controls the switches 202 to configure the bandgap reference circuit 20 to operate in corresponding plural calibration configurations. Within these calibration configurations, each of the first subset of variance parameters among the plural variance parameters is measured separately to individually calibrate or correct the impact of each variance in the first subset on the temperature coefficient or offset voltage of the bandgap reference voltage Vref. It should be noted that the offset voltage refers to the offset component in the bandgap reference voltage Vref that does not affect the temperature coefficient of the bandgap reference voltage Vref.

On the other hand, in one embodiment, the above-mentioned calibration process includes measuring the bandgap reference voltage Vref after the calibration of the first subset of variance parameters is completed, and based on the measured bandgap reference voltage Vref, calculating and calibrating the second subset of variance parameters.

It is noteworthy that, because the calibration process of the temperature coefficient and offset voltage of the bandgap reference voltage Vref in the bandgap reference circuit 20 of the present invention calibrate the variance parameters that can affect the temperature coefficient and offset voltage of the bandgap reference voltage Vref individually, in one embodiment, the aforementioned calibration process can be performed at a single temperature, such as 25 degrees Celsius, to measure and calibrate plural variance parameters. Thus, many variance parameters affecting the temperature coefficient and offset voltage of the bandgap reference voltage Vref can be calibrated at a single preset temperature. That is, thorough and comprehensive calibration of the temperature coefficient and offset voltage of the bandgap reference voltage Vref can be achieved without changing or even without controlling the ambient temperature.

Furthermore, based on the above-mentioned principle of individual calibration of variance parameters, in another embodiment, at the moment of measuring the variance parameters, the calibration process can measure the present ambient temperature of the bandgap reference circuit 20 by a thermometer and calculate the calibration amount corresponding to the variations of the parameters based on the present ambient temperature. Specifically, in this embodiment, the ambient temperature at which each variance parameter is measured can be the same or different, yet it is still possible to calculate the required calibration amounts for each set of variance parameters based on the measured values of the variance and their respective recorded ambient temperatures at the time of measurement. This enables thorough and comprehensive calibration of the temperature coefficient and offset voltage of the bandgap reference voltage Vref, whether or not the ambient temperature is controlled.

From another perspective, the temperature coefficient and offset voltage of the bandgap reference voltage Vref can be calibrated through direct or indirect measurement of the variations of the plural variance parameters. Directly measurable variance parameters include, for example, the current gain β of bipolar transistor, while indirectly measurable variance parameters include, for example, the non-ideal factor ηF and the reverse saturation current Is of bipolar transistor. On the other hand, the unit resistances of the plural resistors R1 to R6 and RT are both directly and indirectly measurable. Direct measurement refers to a measurement that can directly obtain a measured value by a standard industrial measurement tool, such as, using a multimeter to directly measure the resistance or the current gain β, while indirect measurement refers to a measurement that is not directly supported by a standard industrial measurement tool, but the measurement result can be obtained by calculation according to the measurements of other parameters.

Depending on the impact on the bandgap reference voltage Vref, the plural variance parameters can be categorized in another way. For example, one group of the variance parameters can include those affecting the temperature coefficient of the bandgap reference voltage Vref, and another group of the variance parameters can include those affecting the offset voltage of the bandgap reference voltage Vref (which may have no impact or little impact on the temperature coefficient of the bandgap reference voltage Vref). The temperature coefficient variance parameters may include the unit resistances, current gain β, and/or reverse saturation current Is, whose variance, if not zero, will affect the temperature coefficient of the bandgap reference voltage Vref. The offset voltage variance parameters may include the non-ideal factor ηF, whose variance, if not zero, will affect the offset voltage of the bandgap reference voltage Vref.

In one embodiment, the aforementioned calibration process further includes adjusting a first adjustment parameter related to the temperature coefficient of the bandgap reference voltage Vref according to the variation of at least one temperature coefficient variance parameter, so as to calibrate the impact of the variation of at least one temperature coefficient variance parameter on the bandgap reference voltage Vref.

Specifically, referring to the equations (2) and (4) mentioned earlier, in one embodiment, the first adjustment parameter may be K, which is equal to (Rv2/Rv5), as mentioned in the equation (4). From one perspective, K represents the ratio between the temperature coefficients of the positive temperature coefficient signal ΔVbe and the negative temperature coefficient signal Veb2; by adjusting K, the temperature coefficient of the bandgap reference voltage Vref adjusted. In one embodiment, K can be adjusted by modifying the resistance Rv2 of the resistor R2 and/or the resistance Rv5 of the resistor R5. In a preferred embodiment, the resistance Rv5 of the resistor R5 can be adjusted independently without affecting other parameters, while in contrast, adjusting the resistance Rv2 of the resistor R2 will necessitate adjustments of the resistances of the resistor R1 and other resistors. It should be noted that in this embodiment, the first adjustment parameter, that is, the temperature coefficient ratio K, corresponds to the gain K shown in FIG. 2.

On the other hand, in one embodiment, the calibration process further includes adjusting a second adjustment parameter related to the offset voltage of the bandgap reference voltage Vref according to the variation of at least one offset voltage variance parameter, so as to calibrate the impact of the variation of at least one offset voltage variance parameter on the bandgap reference voltage Vref. Referring to the equation (2) mentioned earlier, in one embodiment, the second adjustment parameter can be the gain A of the bandgap reference voltage Vref, which is equal to (Rv6/Rv2) as mentioned in the equation (3). In one embodiment, the gain A can be adjusted by adjusting the resistance Rv2 of the resistor R2 and/or the resistance Rv6 of the resistor R6. In a preferred embodiment, the resistance Rv6 of the resistor R6 can be adjusted independently without affecting other parameters. It should be noted that in this embodiment, the second adjustment parameter, that is, the gain A of the bandgap reference voltage Vref, corresponds to the gain A shown in FIG. 2.

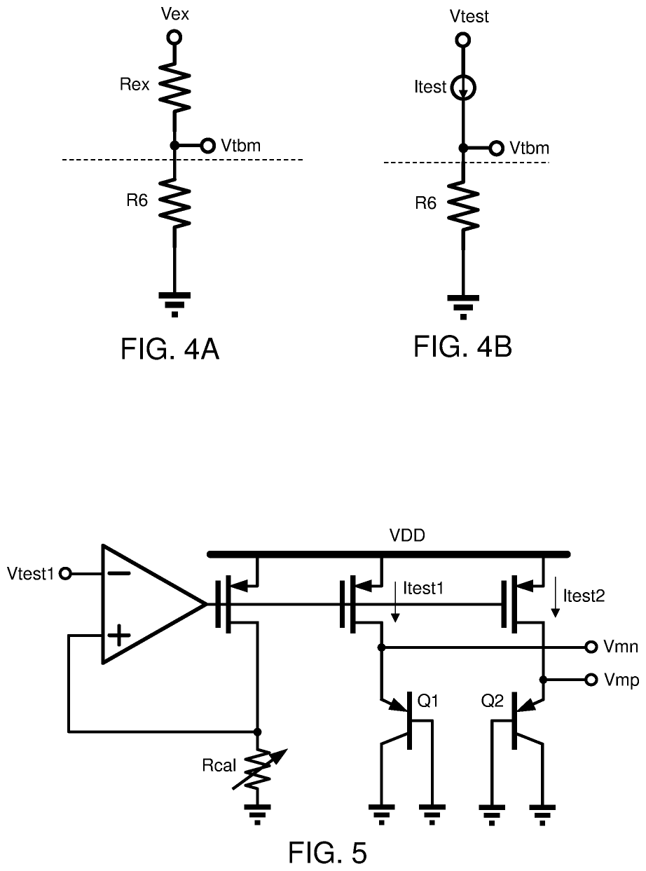

FIG. 4A shows a schematic diagram of a resistance calibration configuration according to an embodiment of the present invention. As shown in FIG. 4A, during the calibration process, the plural switches 200 configure at least one resistor, such as the resistor R6, to operate in a resistance calibration configuration. This configuration includes controlling the switches 200 to connect an external resistor Rex with the resistor R6 in series between an external test voltage Vex and ground; next measuring the to-be-measured signal Vtbm in a voltage divider manner to obtain the resistance Rv6 of the resistor R6, thereby calculating the variation of the unit resistance, so as to calibrate the impact of the variation of the unit resistance on the temperature coefficient of the bandgap reference voltage Vref.

FIG. 4B shows a schematic diagram of a resistance calibration configuration according to another embodiment of the present invention. In another embodiment, a current source Itest is used to generate a current flowing through the resistor R6, and the to-be-measured signal Vtbm is measured to calculate the resistance Rv6 of the resistor R6, so as to obtain the variation of the unit resistance. In one embodiment, the impact of correcting the variation of the unit resistance on the temperature coefficient of the bandgap reference voltage Vref can be adjusted by adjusting the aforementioned gain K.

FIG. 5 shows a schematic diagram of a non-ideal factor calibration configuration according to an embodiment of the present invention. As shown in FIG. 5, during the calibration process, the plural switches 200 configure the bipolar transistors 201 to operate in a non-ideal factor calibration configuration, which involves: controlling the switches 200 to provide test input currents Itest1 and Itest2 to bipolar transistors Q1 and 02, respectively, so that the bipolar transistors Q1 and Q2 have different current densities. The test input currents Itest1 and Itest2 are determined by the test input voltages Vtest1 and the resistance of the adjustment resistor Rcal; next, in the non-ideal factor calibration configuration, the voltage difference ΔVbe between the base-emitter voltages of the bipolar transistors Q1 and Q2 (which is the difference between the voltages Vmn and Vmp) is measured to calculate the variation of the non-ideal factor n, so as to calibrate the impact of the non-ideal factor ηF on the offset voltage of the bandgap reference voltage Vref. In one embodiment, the impact of correcting the variation of the non-ideal factor ηF on the offset voltage of the bandgap reference voltage Vref can be adjusted by adjusting the aforementioned gain A.

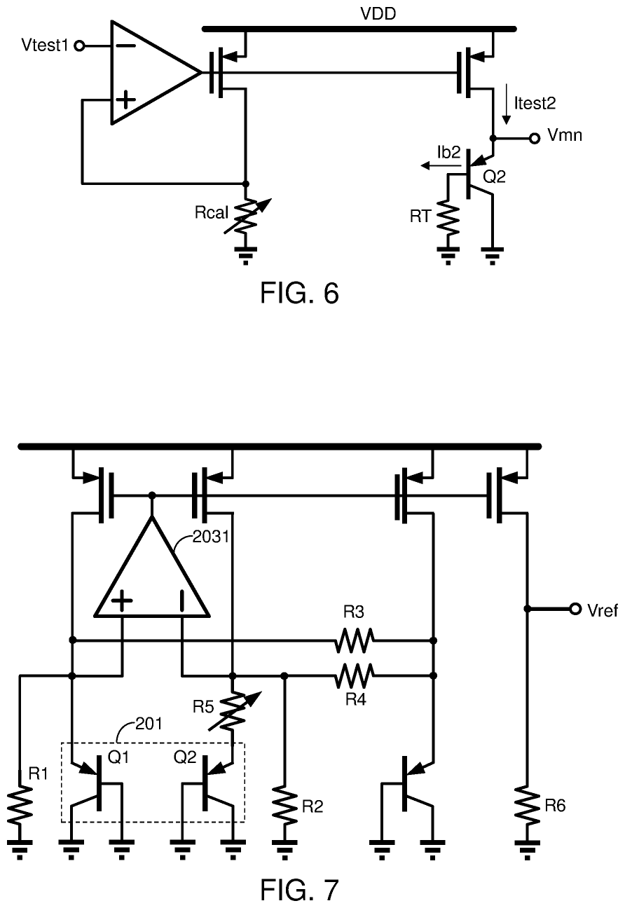

FIG. 6 shows a schematic diagram of a current gain calibration configuration according to an embodiment of the present invention. As depicted in FIG. 6, during the calibration process, the plural switches 200 configure the bipolar transistors 201 to operate in a current gain calibration configuration, which involves: controlling the switches 200 to provide a test input signal Itest2 to the emitter of one of the bipolar transistors, e.g., the bipolar transistor Q2, and measuring the base current Ib2 of the bipolar transistor Q2 to calculate the variation of the current gain β, so as to calibrate the impact of the variation of the current gain Bon the temperature coefficient of the bandgap reference voltage Vref. The base current Ib2 can be determined by measuring the voltage across resistor RT. In one embodiment, the impact of correcting the variation of the current gain β on the temperature coefficient of the bandgap reference voltage Vref can be adjusted by adjusting the aforementioned gain K.

FIG. 7 shows a schematic diagram of a reverse saturation current calibration configuration according to an embodiment of the present invention. As depicted in FIG. 7, during the calibration process, the plural switches 200 configure the bandgap reference circuit 20 to operate in a reverse saturation current calibration configuration, which involves: after the variation of the first subset of variance parameters have been calibrated, controlling the switches 200 to configure the bandgap reference circuit in a coupled state to generate the bandgap reference voltage Vref; next, measuring the error of the bandgap reference voltage Vref, and based on this error, the variation of the reverse saturation current Is is calibrated to calibrate the impact of the variation of the reverse saturation current Is on the temperature coefficient of the bandgap reference voltage Vref. In one embodiment, the impact of correcting the variation of the reverse saturation current Is on the temperature coefficient of the bandgap reference voltage Vref can be adjusted by adjusting the aforementioned gain K.

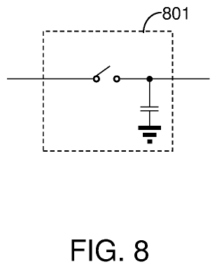

Furthermore, it should be clarified that the embodiments described above are demonstrated primarily by using resistors and their resistances as examples, but the present invention is not limited to these embodiments. The resistors can be replaced by other impedance devices, such as the impedance device 801 shown in FIG. 8, which is composed of a switchable capacitor circuit. In other words, the present invention is also applicable to bandgap reference circuits that include switchable capacitors. From a broader perspective, the aforementioned resistors and resistances can correspond to impedance devices and impedance values, respectively.

In summary, the present invention can achieve effective improvement of the accuracy of single-point temperature calibration of the bandgap reference voltage by means of measuring and adjusting plural parameters.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. The various embodiments described above are not limited to being used alone; two embodiments may be used in combination, or a part of one embodiment may be used in another embodiment. For example, other process steps or structures, such as a metal silicide layer, may be added. For another example, the lithography process step is not limited to the mask technology but it can also include electron beam lithography, immersion lithography, etc. Therefore, in the same spirit of the present invention, those skilled in the art can think of various equivalent variations and various combinations, and there are many combinations thereof, and the description will not be repeated here. The scope of the present invention should include what are defined in the claims and the equivalents.

What is claimed is:

1. A bandgap reference circuit comprising:
a plurality of bipolar transistors, including a first bipolar transistor and a second bipolar transistor, wherein the first bipolar transistor and the second bipolar transistor are biased at different current densities;
a plurality of impedance devices of a same type;
a plurality of switches; and
a feedback control circuit, including an amplifier and a part of the impedance devices, wherein a first input terminal of the amplifier is coupled to the first bipolar transistor, and a second input terminal of the amplifier is coupled to the second bipolar transistor through one of the part of impedance devices;
wherein the plurality of bipolar transistors, the plurality of impedance devices, and the feedback control circuit are configured to generate a positive temperature coefficient signal and a negative temperature coefficient signal, and to generate a bandgap reference voltage according to a linear superposition of the positive temperature coefficient signal and the negative temperature coefficient signal;
wherein the bandgap reference circuit has a plurality of variance parameters affecting a temperature coefficient and/or an offset voltage of the bandgap reference voltage, wherein in a calibration process, the plurality of switches are controlled to configure the bandgap reference circuit to operate in a plurality of corresponding calibration configurations, and in the calibration configurations, a first subset of the variance parameters are measured separately, to individually calibrate an impact of a variation of each of the first subset of variance parameters on the temperature coefficient or the offset voltage of the bandgap reference voltage, wherein the offset voltage refers to an offset component in the bandgap reference voltage that is independent of temperature.

2. The bandgap reference circuit as claimed in claim 1, wherein the first subset of variance parameters include at least one of the following: a unit impedance value related to the plurality of impedance devices, a current gain of the plurality of bipolar transistors, and a non-ideal factor.

3. The bandgap reference circuit as claimed in claim 2, wherein the plurality of variance parameters includes a second subset of variance parameters, wherein the calibration process further includes:
measuring the bandgap reference voltage after the first subset of variance parameters have been calibrated, and
based on the measured bandgap reference voltage, calculating and calibrating the second subset of variance parameters.

4. The bandgap reference circuit as claimed in claim 3, wherein the second subset of variance parameters include a reverse saturation current of the bipolar transistors.

5. The bandgap reference circuit as claimed in claim 3, wherein the calibration process further includes: measuring and calibrating the first subset and the second subset of variance parameters at a single temperature, so that the calibration of the temperature coefficient and offset voltage of the bandgap reference voltage is achieved at the single temperature.

6. The bandgap reference circuit as claimed in claim 3, wherein the calibration process further includes:
when measuring each of the variance parameters, also measuring a present ambient temperature of the bandgap reference circuit by a thermometer, and
based on a variation of the variance parameter and a corresponding present ambient temperature, measuring and calibrating the first subset and second subset of variance parameters, to achieve calibration of the temperature coefficient and offset voltage of the bandgap reference voltage.

7. The bandgap reference circuit as claimed in claim 6, wherein the calibration process further includes: not controlling the ambient temperature.

8. The bandgap reference circuit as claimed in claim 1, wherein the plurality of variance parameters are calibrated by steps including a direct or indirect measurement.

9. The bandgap reference circuit as claimed in claim 4, wherein the first subset of variance parameters and/or the second subset of variance parameters include at least one temperature coefficient variance parameter that affects the temperature coefficient of the bandgap reference voltage, wherein the calibration process further includes: adjusting a first adjustment parameter related to the temperature coefficient of the bandgap reference voltage according to a variation of the at least one temperature coefficient variance parameter, thereby calibrating an impact of the variation of the at least one temperature coefficient variance parameter on the bandgap reference voltage.

10. The bandgap reference circuit as claimed in claim 9, wherein the first adjustment parameter is related to a ratio between the positive temperature coefficient signal and the negative temperature coefficient signal.

11. The bandgap reference circuit as claimed in claim 9, wherein the at least one temperature coefficient variance parameter includes the unit impedance value, the current gain, and/or the reverse saturation current.

12. The bandgap reference circuit as claimed in claim 4, wherein the plurality of variance parameters includes at least one offset voltage variance parameter that affects the offset voltage of the bandgap reference voltage, wherein the calibration process further includes: adjusting a second adjustment parameter related to the offset voltage of the bandgap reference voltage according to a variation of the at least one offset voltage variance parameter, thereby calibrating an impact of the variation of the at least one offset voltage variance parameter on the bandgap reference voltage.

13. The bandgap reference circuit as claimed in claim 12, wherein the second adjustment parameter is related to a gain of the bandgap reference voltage.

14. The bandgap reference circuit as claimed in claim 12, wherein the at least one offset voltage variance parameter includes the non-ideal factor.

15. The bandgap reference circuit as claimed in claim 2, wherein during the calibration process, the plurality of switches configure at least one of the plurality of impedance devices to operate in an impedance value calibration configuration, which includes:
controlling the plurality of switches, so as to measure and obtain an impedance value of the at least one impedance device by voltage division or by a current source generating a current through the at least one impedance device, thereby calculating a variation of the unit impedance value to calibrate an impact of the variation of the unit impedance value on the temperature coefficient of the bandgap reference voltage.

16. The bandgap reference circuit as claimed in claim 2, wherein during the calibration process, the plurality of switches configure the plurality of bipolar transistors to operate in a non-ideal factor calibration configuration, which includes:
controlling the plurality of switches, so as to respectively provide currents to the first and second bipolar transistors to generate different current densities in the first and second bipolar transistors, and
measuring a difference between base-emitter voltages of the first and second bipolar transistors to calculate a variation of the non-ideal factor, thereby calibrating an impact of the variation of the non-ideal factor on the offset voltage of the bandgap reference voltage.

17. The bandgap reference circuit as claimed in claim 2, wherein during the calibration process, the plurality of switches configure the plurality of bipolar transistors to operate in a current gain calibration configuration, which includes:
controlling the plurality of switches, so as to provide current to an emitter of one of the bipolar transistors; and
measuring a base current of this one bipolar transistor to calculate a variation of the current gain, to thereby calibrate an impact of the variation of the current gain on the temperature coefficient of the bandgap reference voltage.

18. The bandgap reference circuit as claimed in claim 4, wherein during the calibration process, the plurality of switches configure the bandgap reference circuit to operate in a reverse saturation current calibration configuration, which includes:
after the first subset of variance parameters have been calibrated, controlling the plurality of switches, so as to measure an error in the bandgap reference voltage; and
based on this error in the bandgap reference voltage, calibrate an impact of the variation in the reverse saturation current on the temperature coefficient of the bandgap reference voltage.

19. A method for testing and calibrating a bandgap reference circuit, wherein the bandgap reference circuit is configured to generate a positive temperature coefficient signal and a negative temperature coefficient signal, and generate a bandgap reference voltage according to a linear superposition of the positive and negative temperature coefficient signal signals, wherein the bandgap reference circuit has a plurality of variance parameters affecting a temperature coefficient and/or an offset voltage of the bandgap reference voltage, and the bandgap reference circuit including a plurality of switches, the method comprising:
controlling the plurality of switches to configure the bandgap reference circuit in corresponding calibration configurations, and
in the corresponding calibration configurations, measuring a first subset of variance parameters respectively to calibrate an impact of a variation of each of the first subset of variance parameters on the temperature coefficient or offset voltage of the bandgap reference voltage, wherein the offset voltage refers to a component of the bandgap reference voltage that is independent of temperature.

20. The method as claimed in claim 19, wherein the bandgap reference circuit includes a plurality of impedance devices and a plurality of bipolar transistors, and the first subset of variance parameters includes at least one of the following: a unit impedance value related to the plurality of impedance devices, a current gain of the plurality of bipolar transistors, and a non-ideal factor.

21. The method as claimed in claim 20, wherein the plurality of variance parameters include a second subset of variance parameters, and the method further comprises:
measuring the bandgap reference voltage after the first subset of variance parameters have been calibrated, and
based on the measured bandgap reference voltage, calculating and calibrating the second subset of variance parameters.

22. The method as claimed in claim 21, wherein the second subset of variance parameters includes a reverse saturation current of the bipolar transistors.

23. The method as claimed in claim 21, further comprising:
measuring and calibrating the first subset and the second subset of variance parameters at a single temperature, so that the calibration of the temperature coefficient and offset voltage of the bandgap reference voltage is achieved at the single temperature; or,
the method further comprising:
when measuring each of the variance parameters, also measuring a present ambient temperature of the bandgap reference circuit by a thermometer, and
based on a variation of the variance parameter and a corresponding present ambient temperature, measuring and calibrating the first subset and second subset of variance parameters, to achieve calibration of the temperature coefficient and offset voltage of the bandgap reference voltage.

24. The method as claimed in claim 23, further comprising: not controlling the ambient temperature.

25. The method as claimed in claim 22, wherein the first and/or second subset of variance parameters include at least one temperature coefficient variance parameter that affects the temperature coefficient of the bandgap reference voltage, and wherein the method further includes:
adjusting a first adjustment parameter related to the temperature coefficient of the bandgap reference voltage according to a variation of the at least one temperature coefficient variance parameter, thereby calibrating an impact of the variation of the at least one temperature coefficient variance parameter on the bandgap reference voltage.

26. The method as claimed in claim 25, wherein the first adjustment parameter is related to a ratio between the positive temperature coefficient signal and the negative temperature coefficient signal.

27. The method as claimed in claim 25, wherein the at least one temperature coefficient variance parameter includes the unit impedance value, the current gain, and/or the reverse saturation current.

28. The method as claimed in claim 22, wherein the plurality of variance parameters includes at least one offset voltage variance parameter that affects the offset voltage of the bandgap reference voltage, and wherein the method further includes: adjusting a second adjustment parameter related to the offset voltage of the bandgap reference voltage according to a variation of the at least one offset voltage variance parameter, thereby calibrating an impact of the variation of the at least one offset voltage variance parameter on the bandgap reference voltage.

29. The method as claimed in claim 27, wherein the second adjustment parameter is related to a gain of the bandgap reference voltage.

30. The method as claimed in claim 27, wherein the at least one offset voltage variance parameter includes the non-ideal factor.
